(19) United States
(12) Patent Application Publication
(10) Pub. No.: US 2009/0052202 A1
(43) Pub. Date: Feb. 26, 2009

(54) Vehicle lamp fixing device

(75) Inventors: Hsi-Hsien Tsai, Tainan City (TW); Ko-Chun Pan, Tainan City (TW)

Correspondence Address: Hsi-Hsien TSAI, P.O. Box 90, Tainan City 70499, TW

(73) Assignee: LUCIDITY ENTERPRISE CO., LTD.

(21) Appl. No.: 11/892,043

(22) Filed: Aug. 20, 2007

(51) Int. Cl. B60Q 1/00

(52) U.S. Cl. 362/549

(57) ABSTRACT

A vehicle lamp fixing device includes at least an engage groove in a rear wall of a lamp socket, the engage groove provided with an opening formed in an outer side, and an elastic stop lug formed in a sidewall of the engage groove. The elastic stop lug can be pressed to retreat in the sidewall so as to let the shank of a bolt to pass over, and then recover to its original position to stop the shank of the bolt not to fall out of the opening, so the bolt can be held in the engage groove without using a finger so that a worker can conveniently fix the lamp socket on a vehicle body.

### BACKGROUND OF THE INVENTION

1. Field of the Invention This invention relates to a vehicle lamp fixing device, particularly to one having an engage groove in a rear wall of a lamp socket, and an opening formed in an outer side of the engage groove, and an elastic stop lug provided in a side wall of the engage groove for blocking the shank of a bolt from sliding out of the engage groove for a worker to fix the vehicle lamp on a vehicle body.

2. Description of the Prior Art

A conventional vehicle lamp fixing device shown in FIGS. 1 and 2 includes plural engage grooves 10 formed in a rear wall of a lamp socket, and each engage groove 10 has an opening 100 in an outer side. The opening 100 has a smaller width than that of the engage groove 10, so the head 20 of a bolt 2 can fit slidably in the engage groove 10 and the shank 21 of the bolt 2 can fit movably in and extend out of the opening 100 so as to engage with a nut. Then the vehicle lamp with its socket can be fixed on a vehicle body.

However, the shank 21 of a bolt 2 extending out of the opening 100 is impossible to be held stably, possible to easily fall out of a lower end of the opening 100. So a worker has to hold the shank 21 of a bolt 2 with a finger to prevent the bolt 2 with the shank 21 from sliding out of the opening 100. Therefore, it is very inconvenient to handle.

### SUMMARY OF THE INVENTION

This invention has been devised to offer a vehicle lamp fixing device possible to hold a bolt from sliding out of the engage groove and the opening of the engage groove of a lamp socket for conveniently fixing a vehicle lamp with its socket on a vehicle body.

The feature of the invention is an elastic stop lug provided in a sidewall of the engage groove of a lamp socket.

### BRIEF DESCRIPTION OF DRAWINGS

This invention will be better understood by referring to the accompanying drawings, wherein:

FIG. 1 is a perspective view of an engage groove formed in a rear wall of a conventional lamp socket;

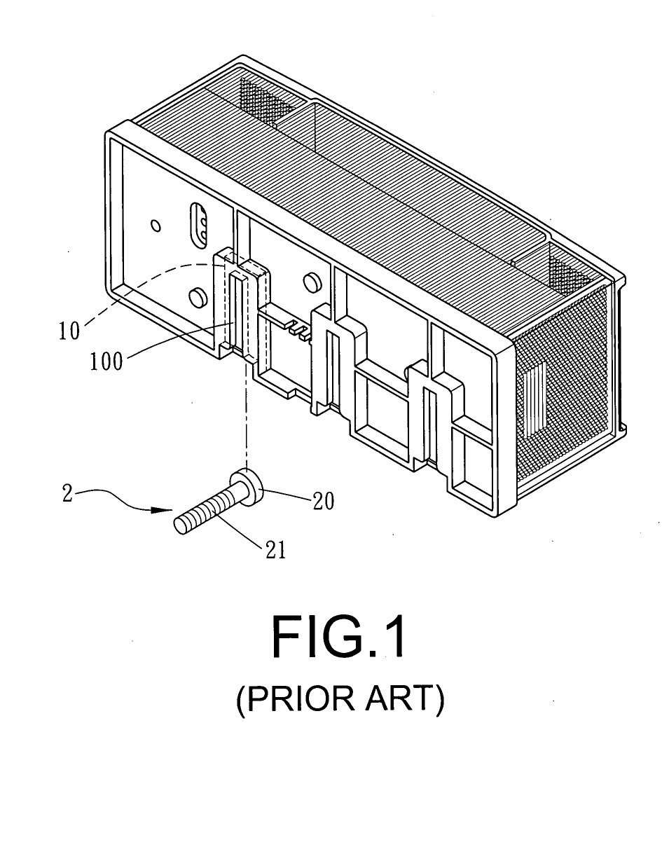

FIG. 2 is a front view of a bolt fitted in the engage groove of the conventional lamp socket;

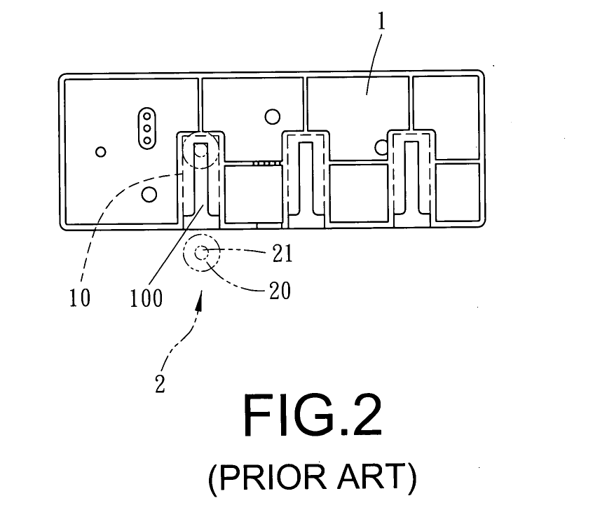

FIG. 3 is a perspective view of a vehicle lamp fixing device in the present invention; and,

FIG. 4 is a front view of a bolt fitted in an engage groove of the vehicle fixing device in the present invention.

### DETAILED DESCRIPTION OF THE PREFERRED EMBODIMENT

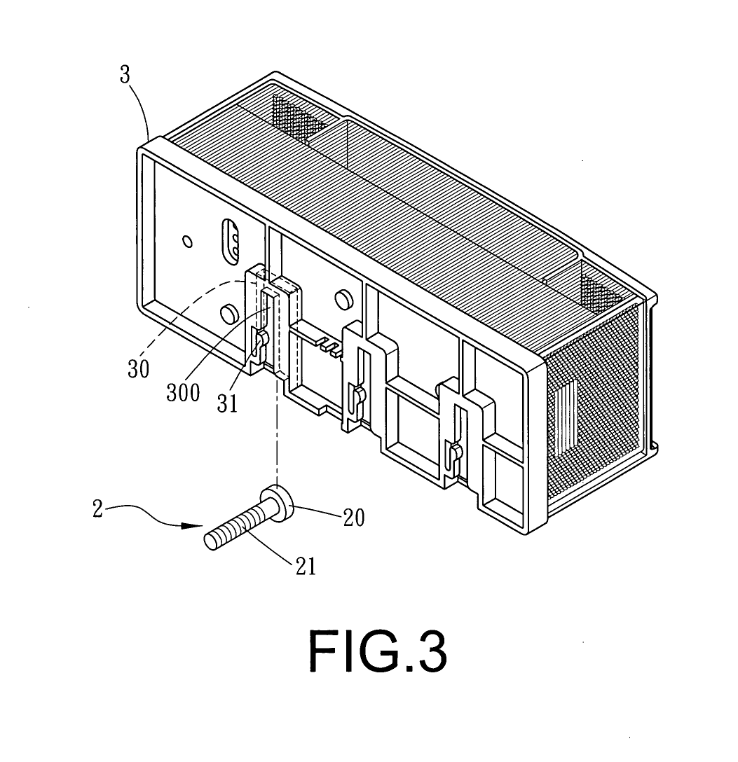

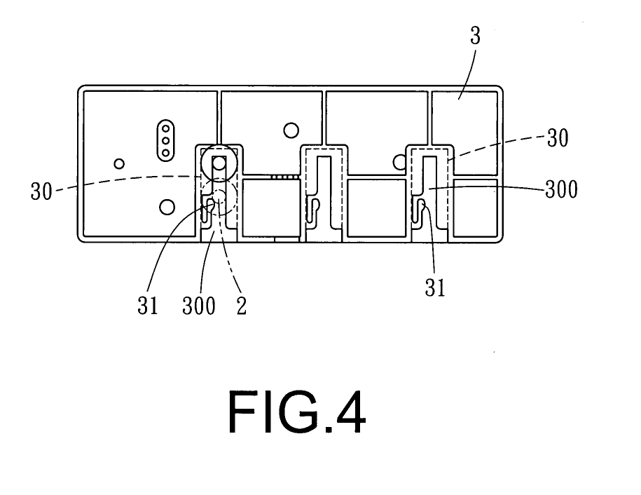

A preferred embodiment of a vehicle lamp fixing device in the present invention, as shown in FIGS. 3 and 4, includes an engage groove 30 formed in a rear wall of a lamp socket 3, an opening 300 formed in an outer side of the engage groove 30. The opening 300 has a width smaller than that of the engage groove 30, with the engage groove 30 being for the head 20 of a bolt 2 to fit movably therein, and with the opening 300 being for the shank 21 of the bolt 2 to fit movably therein. Further, an elastic block lug 31 is provided in a sidewall of the engage groove 30, having its outer end protruding a little in the opening 300 and some elasticity to recover its original position after shoved off the opening.

In fixing a vehicle lamp on a vehicle body, the head 20 of a bolt 2 is inserted in the engage groove 30, with the shank 21 fitting in the opening 300 at the same time and shoved upward with a little force to press the elastic stop lug 31 to retreat in the sidewall, so the shank 21 can pass over the stop lug 31 to move up in an upper portion of the opening 300. Then the shank 21 of the bolt 2 may be stopped by the stop lug 31, which then recovers to its original position of extending in the opening 300. Then the bolt 2 cannot slide out of the engage groove 30 and the opening 300 hampered by the elastic stop lug 31 so that a worker can proceed fixing a vehicle lamp with its socket with convenience, without need of keeping the shank 21 immovable with a finger.

While the preferred embodiment of the invention has been described above, it will be recognized and understood that various modifications may be made therein and the appended claimed are intended to cover all such modifications that may fall within the spirit and scope of the invention.

What is claimed is:

1. A vehicle lamp fixing device comprising an engage groove formed in a rear wall of a lamp socket, said engage groove provided with an opening in an outer side, and characterized by an elastic stop lug formed in a sidewall of said engage groove and having its outer end movably protruding a little in said opening.
